(19) United States
(12) Patent Application Publication
(10) Pub. No.: US 2009/0229418 A1
(43) Pub. Date: Sep. 17, 2009

(54) HAND-HELD DEVICE FOR REMOVING AN ENCLOSURE FROM A CONTAINER

(75) Inventors: Michael GARMAN, Midlothian, VA (US); George W. STAMPER, III, Quinton, VA (US); Brandon SONG, Midlothian, VA (US); Robert H. ROTH, Cincinnati, OH (US); Ken HOGUE, Mason, OH (US); Bob BEST, Cincinnati, OH (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Hamilton Beach Brands, Inc., Glenn Allen, VA (US)

(21) Appl. No.: 12/403,784

(22) Filed: Mar. 13, 2009

Related U.S. Application Data
(60) Provisional application No. 61/036,332, filed on Mar. 13, 2008.

(51) Int. Cl. B67B 7/00; B67B 7/14

(52) U.S. Cl. 81/3.2; 81/3.4

(57) ABSTRACT

A device for removing an enclosure from a container includes a housing at least partially enclosing at least one reversible motor and at least two spaced-apart cams. The cams are rotatable in a first rotational direction in which the cams grasp the container and in a second rotational direction in which the cams are rotated a predetermined distance away from the container. A wrench disk is operatively connected to and rotatable by the at least one motor. At least two spaced-apart wrenches are pivotally attached to the wrench disk for removably grasping the enclosure. Operation of the motor in a first direction rotates the wrench disk in a first rotational direction causing the wrenches to grasp and rotate the enclosure relative to the container. Operation of the motor in a second direction rotates the wrench disk in a second rotational direction causing the wrenches to rotate a predetermined distance away from the enclosure.

### CROSS-REFERENCE TO RELATED APPLICATIONS

The present application claims the benefit of U.S. Provisional Patent Application No. 61/036,332, filed Mar. 13, 2008 and entitled “Device for Removing an Enclosure from a Container.”

### BACKGROUND OF THE INVENTION

This invention generally relates to the removal of an enclosure from a container and, more particularly, to a jar opener or other similar hand-held device that rotatably removes a lid or other type of enclosure device from a jar or similar container.

It is well known that placing foodstuff into an enclosed jar or other container is advantageous to the preservation of the foodstuff. Specifically, producers, distributors and manufactures of various types of foodstuff often fasten the enclosure or lid to ajar or other container very tightly (e.g., air tight) to assure that the contents within the container are preserved throughout the shipment and shelf-life of the foodstuff. This process is advantageous because it allows for the preservation of the foodstuff for a relatively long period of time. However, such tightly secured enclosures or lids often become difficult for the end-user or consumer to remove from the container. To assist consumers or end-users in removing the enclosure or lid, various devices have been produced.

Specifically, there exists a variety of can or jar openers that allow the user to remove the enclosure or lid without directly gripping the lid. For example, there exists motorized jar openers that attach directly to the underside of a cabinet that allow the user to hold the jar or container body while the jar opener rotates the lid or enclosure to overcome the friction force inherent to the connection. However, there are drawbacks to this type of device. For instance, the jar openers require a solid or stable location to mount the jar opener, and the user is required to directly hold the jar or container body which may cause pain or discomfort to the user. Further, individuals with arthritis or other similar symptoms may have difficulty using such jar openers.

In addition, there exists jar openers that allow the user to directly grip the enclosure or lid and provide the user with increased leverage or friction force to remove the enclosure or lid from the container. For example, there exists gloves that a user places on or over the hands. The gloves including dimples or other protruding gripping surfaces on the palm and finger portions to provide increased friction to the user. However, there are disadvantages to these types of jar openers. Specifically, these types of openers require that the user directly hold the jar or container as well as the lid, which often causes discomfort or pain to certain individuals.

Therefore, it would be desirable to create at least a partially automated hand-held device for removing enclosures or lids from containers that would allow a user to easily remove a lid or enclosure of a jar or other container without having to directly touch or grasp either the container or the enclosure. Specifically, it would be desirable to create a jar opener that provides a degree of “hands-free” operation. Further, it would be desirable to create a jar opener that uses the force and power of a motor to remove the lid from the jar without requiring additional energy or force from the user. Furthermore, it would be desirable to create a user friendly, compact and portable jar opener that can be easily and conveniently stored and/or transported.

### BRIEF SUMMARY OF THE INVENTION

Briefly stated, a preferred embodiment of the present invention is directed to a hand-held device for removing an enclosure from a container. The device includes a housing at least partially enclosing at least one reversible motor and at least two spaced-apart cams pivotally attached to the housing. The cams are rotatable in a first rotational direction in which the cams grasp the container and in a second rotational direction in which the cams are rotated a predetermined distance away from the container. A wrench disk is operatively connected to and rotatable by the at least one motor. At least two spaced-apart wrenches are pivotally attached to the wrench disk for removably grasping the enclosure. Operation of the motor in a first direction rotates the wrench disk in a first rotational direction causing the wrenches to grasp and rotates the enclosure relative to the container. Operation of the motor in a second direction rotates the wrench disk in a second rotational direction causing the wrenches to rotate a predetermined distance away from the enclosure.

In another aspect, a preferred embodiment of the present invention is directed to a hand-held device for removing an enclosure from a container. The device includes a housing at least partially enclosing at least one motor and a ring gear operatively connected to and rotatable by the at least one motor. The ring gear has a pinion extending therefrom. A pair of rack sections are operatively connected to and movable by the pinion. The rack sections are movable in a first linear direction in which a container-gripping portion of each of the rack sections grasp the container and a second linear direction in which the container-gripping portion of each of the rack sections are moved a predetermined distance away from the container. A drive shaft is operatively connected to and rotatable by the at least one motor and at least two spaced-apart wrenches are pivotally attached to the drive shaft for removably grasping the enclosure. Operation of the motor rotates the drive shaft causing the wrenches to rotate in a first rotational direction to grasp and rotate the enclosure relative to the container.

### BRIEF DESCRIPTION OF THE SEVERAL VIEWS OF THE DRAWINGS

The following detailed description of two preferred embodiments of the present invention will be better understood when read in conjunction with the appended drawings. For the purpose of illustrating the invention, there is shown in the drawings two embodiments which are presently preferred. It should be understood, however, that the invention is not limited to the precise arrangements and instrumentalities shown.

In the drawings:

FIG. 1 is a front top perspective view of a hand-held device for removing an enclosure from a container in accordance with a first preferred embodiment of the present invention;

FIG. 2 is a front elevation view of the device shown in FIG. 1;

FIG. 3 is a top right perspective view of the device shown in FIG. 1, with a housing of the device removed for clarity and a drive belt shown in phantom;

FIG. 4 is a top plan view of the device shown in FIG. 1, with the housing removed for clarity and the drive belt shown in phantom;

FIG. 5 is a side elevation view of the device shown in FIG. 1, with the housing removed for clarity and the drive belt shown in phantom;

FIG. 6 is top plan view of a wrench disk and lid wrenches of the device showing in FIG. 1 grasping a enclosure;

FIG. 7 is a perspective view of a hand-held device for removing an enclosure from a container in accordance with a second preferred embodiment of the present invention;

FIG. 8 is top perspective view of the device shown in FIG. 7, with a housing and one gear of a gear train removed for clarity;

FIG. 9 is a partially exploded bottom perspective view of the device shown in FIG. 7, with the housing and one lid wrench removed for clarity;

FIG. 10 is a cross-sectional perspective view of a portion of the device shown in FIG. 7, with the housing, the gear train and at least one lid wrench removed for clarity;

FIG. 11 is a cross-sectional bottom plan view of a portion of an enclosure and a container-gripping mechanism of the device shown in FIG. 7, with portions of the mechanism shown in phantom for clarity;

FIG. 12 is a top plan view of the device shown in FIG. 7, with portions of the device removed for clarity; and

FIG. 13 is a magnified cross-sectional top perspective view of a portion of the device shown in FIG. 7, with portions of the device removed for clarity.

### DETAILED DESCRIPTION OF THE INVENTION

Certain terminology is used in the following description for convenience only, and is not limiting. The words “right,” “left,” “upper,” and “lower” designate directions in the drawings to which reference is made. The terms “a,” “an” and “the” are not limited to one element but should be read as meaning “at least one.” The terminology includes the words above specifically mentioned, derivatives thereof, and words of similar import.

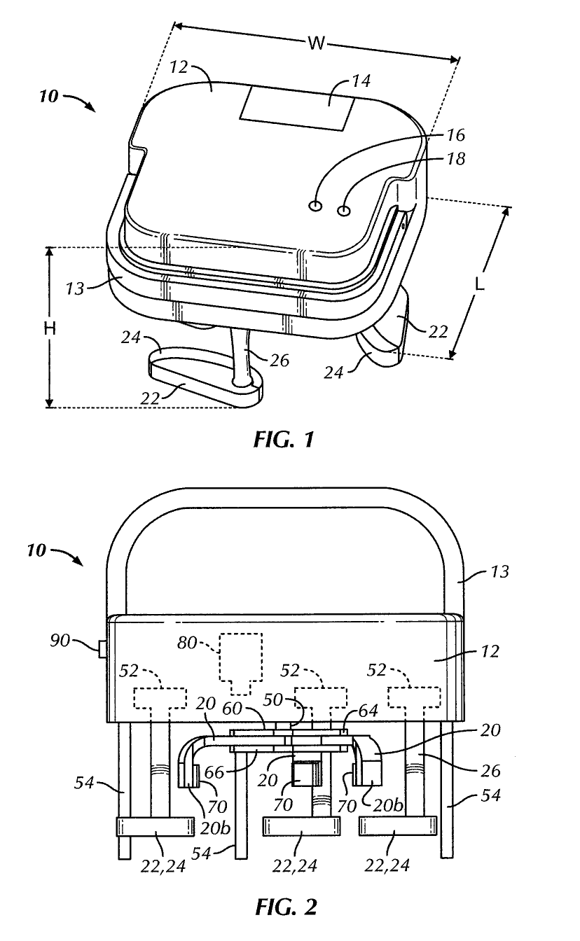

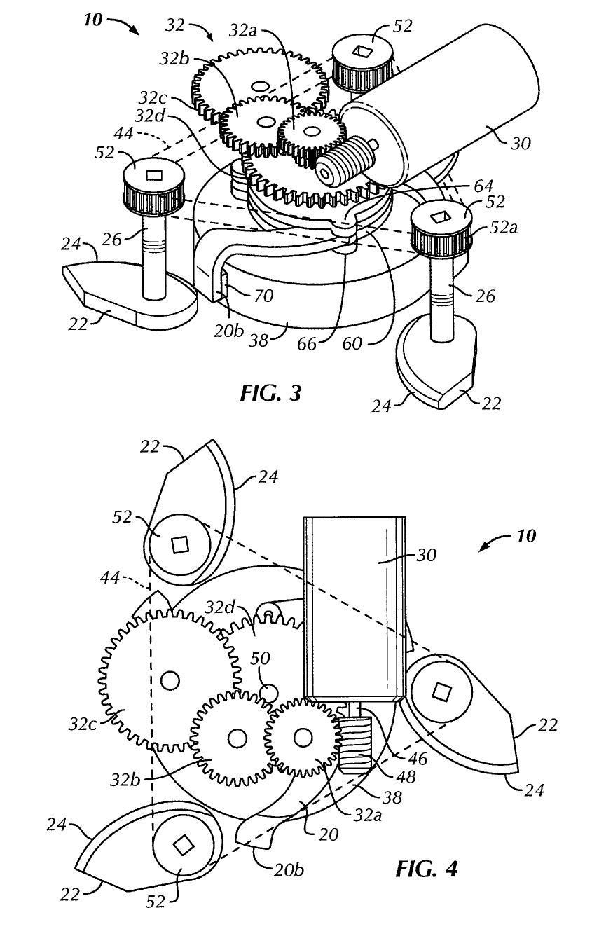

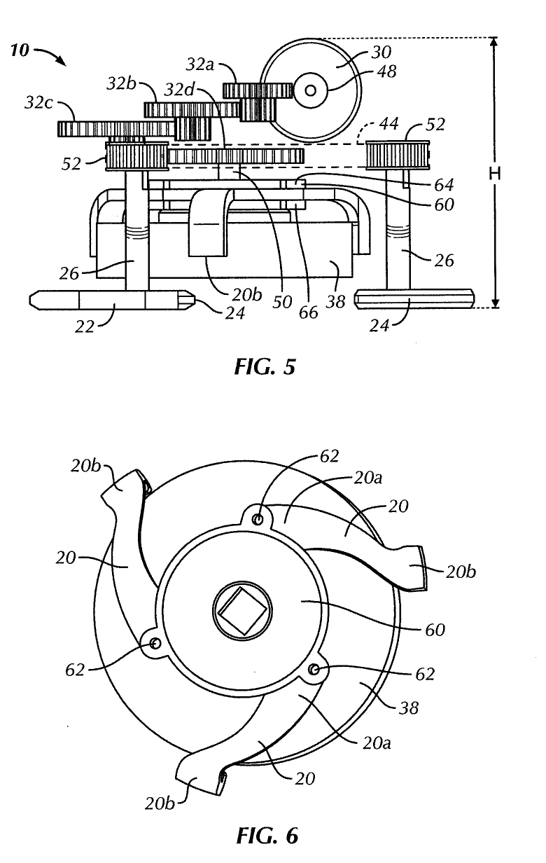

Referring to the drawings in detail, wherein like numerals indicate like elements throughout, there is shown in FIGS. 1-6 a first preferred embodiment of a hand-held device for removing an enclosure from a container, such as a jar opener, indicated generally at 10, in accordance with the present invention. The jar opener 10 is preferably an automated household or kitchen appliance for rotatably removing an enclosure or lid 38 (FIGS. 3-6) from a jar (not shown) or other container (not shown) that provides the user with a degree of “hands-free” operation such that the user does not have to directly hold or grasp the lid 38 or jar or impart energy to remove the lid 38 from the jar. The phrase “hand-held jar opener” is defined herein as a jar opener that does not require direct support from below (i.e., on a table top, countertop or ground surface) or from above (by the underside of a cabinet, for example) to remove a lid from a jar.

As seen in FIGS. 1 and 2, the jar opener 10 includes a generally square-shaped housing 12 having a pivotable handle 13 attached thereto. Preferably, the housing 12 is constructed to be of the smallest size possible to create a more easily used, stored and/or transported jar opener 10. Specifically, the housing 12 of the jar opener 10 of the first preferred embodiments has a height H of approximately 100 mm, a length L of approximately 150 mm and a width W of approximately 150 mm. However, it is preferably that the housing 12 has a height H, length L and width W less than those previously stated. It is understood by those of skill in the art that the size and shape of the housing 12 is not limited to the above-described characteristics, but can be modified without departing from the spirit and scope of the present invention.

The handle 13, which is generally U-shaped, is pivotable between an upright or use position (FIG. 2) in which the handle 12 is generally perpendicular to a top surface of the housing 12 and a collapsed or storage position (FIG. 1) in which the handle 13 is generally parallel to the top surface of the housing 12. It is understood by those skilled in the art that the jar opener 10 is not limited to the inclusion of a handle 13 and the handle 13 and may be modified in size, shape or location without departing from the spirit and scope of the present invention. Further, the handle 13 does not necessarily need to be pivotable. For example, the handle 13 may be locked in any one of a variety of positions if so desired by the user. The housing 12 and handle 13 are preferably formed of a high-strength, light-weight material, such as a polymeric material. However, it is understood by those skilled in the art that the housing 12 and handle 13 may be formed of virtually any other suitable high strength, lightweight material, such as a metallic material.

The jar opener 10 is preferably powered by at least one disposable or rechargeable battery (not shown). The at least one battery is removably mountable within the housing 12 in a battery receptacle 14. The battery receptacle 14 includes a removable cover, as is known in the art, to enclose the battery within the housing 12. Preferably, the battery provides enough power to the jar opener 10 to allow the jar opener 10 to remove at least one hundred lids 38. However, it is understood by those skilled in the art that virtually any type of power source, such as a conventional power cord (not shown) or solar powered energy cells (not shown), may be used to provide energy to the jar opener 10.

The jar opener 10 of the preferred first embodiment is preferably designed to remove lids or enclosures ranging in size from 50 mm to 88 mm in diameter. Further, the jar opener 10 is designed to hold jars or other containers in a stationary or immobile position that have diameters ranging from 50 mm to 88 mm. However, it is understood by those of ordinary skill in the art that the jar opener 10 can be modified to remove enclosures or lids 38 of larger or smaller sizes and of various shapes and to grasp containers of larger or smaller sizes and various shapes.

As seen in FIGS. 3-5, the housing 12 at least partially encloses and/or surrounds at least one reversible motor 30 (i.e., “primary motor”) and a multi-stage gear train 32. A motor drive shaft 46 extends from one side of the motor 30 and rotates a motor pinion 48. The motor pinion 48 is in direct engaging contact with the teeth of a first gear 32a of the gear train 32. Power generated by the motor 30 is transferred from the motor drive shaft 46, through the motor pinion 48, to the first gear 32a. The first gear 32a of the gear train 32 engages and rotates the second gear 32b, which in turn rotates the third gear 32c, which in turn rotates the fourth gear 32d. A vertically extending shaft 50 extends from the center of the fourth and final gear 32d in the gear train 32 through an interior open space or cavity of the housing 12. A second end of the shaft 50 is fixedly connected to a wrench disk 60, which will be described in detail below. Thus, the wrench disk 60 is operatively connected to and rotatable by the primary motor 30. It is understood by those skilled in the art that the gear train 32a-32d is not limited to the exact embodiment described above or shown herein. Alternatively, the gear train 32a-32d may include a greater or lesser number of gears of varying size, shape and/or configuration, for example. The motor 30 and gear train 32a-32d are preferably capable of applying up to 8.5 N-m of torque to the lid 38 of ajar to rotatably remove the lid 38 from the jar in the manner described below.

Referring to FIG. 1, the housing 12 includes a start button 16 and a release button 18 located on an exterior surface thereof. The start and release buttons 16, 18 are operatively connected to the motor 30. Specifically, a printed circuit board PCB control (not shown) located within the housing 12 connects the start and release buttons 16, 18 to the motor 32 and to the battery or other power source. Thus, the start and release buttons 16, 18 allow the user to control the operation of the jar opener 10. The specific operation of the start and release buttons 16, 18 will be described in further detail below. Further, the housing 12 may include additional control buttons (not shown) that turn on the jar opener 10 or activate an illumination feature (not shown), for example. It is understood by those skilled in the art that the jar opener 10 is not limited to the inclusion of the buttons 16, 18 and that the buttons my be modified in size, shape or location without departing from the broad inventive concept thereof. For example, instead of two buttons, the jar opener 10 may be designed to include only one button, the jar opener 10 may be voice activated or the jar opener 10 may include a touch-screen (not shown).

To effectuate removal of the enclosure 38 from the container, the jar opener 10 includes at least two, but preferably three or more, spaced-apart collapsible and/or pivotable lid wrenches 20, which removably engage or grasp the lid. The lid wrenches 20 extend slightly below the housing 12 when viewed from the side (FIG. 2) and are operatively connected to the motor 30 and gear train 32a-32d by the generally circular wrench disk 60. Each lid wrench 20 has a generally arcuate shape when viewed from above (FIGS. 4 and 6). Specifically, a first end 20a of each lid wrench 20 is rotatably connected or pivotally attached to the wrench disk 60 by at a pivot pin 62 located proximate an outer circumference of the wrench disk 60. The wrench disk 60 may be comprised of a single disk or top wrench disk 64 and a bottom wrench disk 66 (FIGS. 2, 3 and 5) that are separated a predetermined distance to allow for a first end 20a of each lid wrench 20 to be pivotally secured therebetween. It is understood by those skilled in the art that the wrench disk 60 may be modified in size, shape and/or location.

As seen in FIGS. 3-6, a second end 20b of each lid wrench 20 is capable of directly grasping the body or sidewall of the lid 38. The wrench disk 60 is directly connected to, and rotated by, the last gear 32d of the gear train 32a-32d. Thus, as the gear train 32a-32d rotates the wrench disk 60 in a counterclockwise direction (when viewed from above), for example, the rotational force of the wrench disk 60 causes each lid wrench 20 to grasp the enclosure or lid 38 of the jar, as is shown in FIG. 6.

The lid wrenches 20 are preferably formed of a high strength, light weight material, such as a metallic material. However, the lid wrenches 20 may be constructed of virtually any material, such as a polymeric material, that can withstand the high stress placed on the lid wrenches 20. As is understood by those skilled in the art, the lid wrenches 20 of the present embodiment are similar in structure to an automotive oil filter wrench. It is understood by those skilled in the art that the lid wrenches 20 are not limited to the particular size, shape or mounting location described above and shown in the attached drawings. For example, the lid wrenches 20 may be replaced by a continuous chain (not shown) that can removably grasp the lid 38 of a jar.

As seen in FIGS. 2 and 3, each lid wrench 20 preferably includes a rubber or thermal plastic elastomer (TPE) grip 70 located on the inner surface of the second end 20b to directly engage the enclosure or lid 38. The grips 70 provide a friction force for holding and gripping the enclosure or lid 38. It is understood by those skilled in the art that the size and shape of the grips 70 can be modified without departing from the spirit and scope of the present invention. For example, each grip 70 may have a slightly concave inner surface to more closely match the shape of the sidewall of the enclosure or lid 38.

To hold the container or jar in an immobile or stable position, the jar opener 10 includes at least two, but preferably three or more, spaced-apart individually collapsible and/or pivotable jar gripping cams 22 for removably gripping the body or sidewall of the jar or container. When viewing the jar opener 10 from the side (FIG. 2), the gripping cams 22 extend in a plane generally parallel to and spaced a predetermined distance away from or below a plane in which at least a portion of the lid wrenches 20 extend. When viewing the jar opener 10 from above (FIG. 4) or below, the gripping cams 22 generally surround the lid wrenches 20. Each gripping cam 22 is generally oblong in shape, having one generally straight outer surface and a generally curved inner surface. The gripping cams 22 are preferably formed of a high strength, light-weight material, such as a metallic material. However, the gripping cams 22 may be constructed of virtually any material, such as a polymeric material, that can withstand the high stresses placed on the gripping cams 22.

Referring to FIGS. 3-5, each gripping cam 22 includes a rubber or thermal plastic elastomer (TPE) pad 24 located on the inner surface thereof to directly engage the jar or container. The pads 24 provide a friction force for holding and gripping the container as the wrenches 20 rotatably remove the lid 38. It is understood by those skilled in the art that the size and shape of the cams 22 and pads 24 can be modified without departing from the spirit and scope of the present invention. For example, each gripping cam 22 may have a slightly concave inner surface to more closely match the shape of the sidewall of a container.

Further, each gripping cam 22 is rotatably secured and/or pivotally attached to the housing 12 via a vertically extending shaft 26. Thus, the jar opener 10 has at least two, but preferably three or more, spaced-apart generally parallel shafts 26, each corresponding to a gripping cam 22. Preferably, each shaft 26 generally extends perpendicularly from a bottom surface of the housing 12. Specifically, a lower end of each shaft 26 is fixedly attached by welding, for example, to a gripping cam 22. An upper end of each shaft 26 extends through a bottom surface of the housing 12 and terminates at a generally circular head 52 situated in a generally open cavity or interior space within the housing 12. The upper end of each shaft 26 is fixedly attached by welding, for example, to a lower surface of the circular head 52.

As seen in FIG. 1, a drive belt 44 (shown in phantom) is at least partially enclosed by the housing 12 and at least partially surrounds a portion of each head 52, such that the gripping cams 22 can be pivoted and/or rotated in a first rotational direction (e.g., inwardly or clockwise direction when viewed from above) and/or in a second rotational direction (e.g., outwardly or counterclockwise direction when viewed from above) as one unit depending on the direction of movement of the drive belt 44. Specifically, an inner surface of the drive belt 44 may include teeth or protrusions (not shown) that engage corresponding teeth or protrusions 52a at a mid-section of each head 52. It is understood by those skilled in the art that the jar opener 10 is not limited to the use of a drive belt 44 to actuate the motion of the cams 22. For example, the drive belt 44 may be replaced by a large ring gear (not shown) or a cable (not shown), for example.

To collapse and/or rotate the gripping cams 22, the housing 12 may include a second reversible motor 80 (i.e., “complimentary motor”) (shown in phantom in FIG. 2) operatively connected to the drive belt 44, which allows the user to automate the rotation of the drive belt 44. Specifically, operation of the complimentary motor 80 in a first direction rotates the drive belt 44 in the first rotational direction (e.g., inwardly or clockwise when viewed from above) causing the gripping cams 22 to grasp the container. Conversely, operation of the complimentary motor 80 in the second direction rotates the drive belt 44 in the second rotational direction (e.g., outwardly or counterclockwise when viewed from above) causing the gripping cams 22 to rotate a predetermined distance away from the container.

In conjunction with the complimentary motor 80, the jar opener 10 may include a switch or lever 90 that is operatively connected to the complimentary motor 80 to allow the user to control the operation of the complimentary motor 80. Specifically, when the user activates the switch or lever 90, the drive belt 44 is preferably rotated in the specified direction to cause the gripping cams 22 to rotate together either inwardly or outwardly from the center of the jar opener 10. Further, the gripping cams 22 may be designed to automatically retract or rotate inwardly toward the jar once power has been supplied to the jar opener 10. For example, once the jar opener 10 has been turned on, the gripping cams 22 may be designed to automatically rotate inwardly after a predetermined time. Further, once the lid wrenches 20 have rotatably removed the lid 38 from the container, the gripping cams 22 may automatically be rotated outwardly, away from the jar or container, after a predetermined time.

It is understood by those skilled in the art that the jar opener 10 is not limited to the inclusion of the switch or lever 90. For example, the gripping cams 22 may be manually. rotated by the user to engage the sidewall of the jar or container since the manual rotation of one of the cams 22 causes all three cams 22 to rotate together. Further, the jar opener 10 is not limited to the inclusion of the complimentary motor 80. Alternatively, the jar opener 10 may include a connector (not shown) on the housing 12 to matingly engage a hand tool (not shown), such as a screw driver. In this embodiment, rotation of the hand tool rotates an adapter (not shown) or set of gears (not shown), which in turn causes rotation of the drive belt 44 in the specified direction.

As seen in FIG. 2, a plurality of spaced-apart legs 54 preferably generally extend orthogonally from a bottom surface of the housing 12 such that the jar opener 10 may be placed on a countertop or tabletop without the gripping cams 22 or the lid wrenches 20 touching the supporting surface. Thus, the legs 54 maintain a predetermined distance between the cams and the supporting surface when the jar opener 10 is placed on the supporting surface. It is understood by those skilled in the art that the jar opener 10 is not limited to the use of the legs 54 or the specific embodiment shown and described herein. For example, there may be more or fewer legs of various size and shape to support the weight of the jar opener 10 on the tabletop or countertop.

To operate the jar opener 10, the user pivots the handle 13 to the upright or use position (FIG. 2) and lifts the entire jar opener 10 above the lid 38 of the jar. Next, the user lowers the entire jar opener 10 onto or proximate the top of the lid 38. Then, the user activates the switch or lever 90 to activate the complimentary motor 80, which in turn causes the drive belt 44 to rotate the gripping cams 22 in the first rotational direction (e.g., inwardly or clockwise when viewed from above) so that the pads 24 of the gripping cams 22 firmly grip the side wall of the jar or container. Alternatively, in an embodiment that does not include the switch or lever 90 or the complimentary motor 80, the user may rotate one of the cams 22 such that all of the cams 22 are pivoted inwardly so that the pads 24 of the cams 22 engage the side wall of the jar or container. Or, the user may rotate a hand tool to effectuate rotation of the drive belt 44, which in turn rotates the three cams 22 in unison.

Next, the user depresses the start button 16 to activate the motor 30 for rotation of the motor drive shaft 46 in the first direction. This rotation of the motor 30 rotates the drive train 32a-32d, which in turn causes the wrench disk 60 to rotate in a first rotational direction (e.g. counterclockwise direction when viewed from above). This rotation of the wrench disk 60 causes each lid wrench 20 to rotate inwardly so that the grip 70 firmly grasps at least a portion of the side wall of the lid 38. At this point, since the gripping cams 22 are securely holding the jar in place, the continued inward rotation of the lid wrenches 20 overcomes the friction force between the lid 38 and the jar and causes the lid 38 to rotate in the unscrew or removal direction with respect to the jar.

To release the cams 22 from the container, the user activates the switch or lever 90 to activate the complimentary motor 80 in a second direction, which in turn causes the drive belt 44 to rotate the gripping cams 22 in the second rotational direction (e.g., outwardly or counterclockwise when viewed from above), such that the cams 22 are rotated a predetermined distance away from the container. Alternatively, in an embodiment that does not include the switch or lever 90 of the complimentary motor 80, the user may rotate one of the cams 22 such that all of the cams 22 are pivoted outwardly a predetermined distance away from the side wall of the jar or container.

Finally, the user may depress the release button 18, which in turn causes the motor 30 and drive train 32a-32d to rotate the wrench disk 60 in the second rotational direction (i.e. clockwise when viewed from above). Alternatively, the wrench disk 60 may be designed to automatically rotate in a clockwise direction after a predetermined time. This rotation of the wrench disk 60 causes the second end 20b of each lid wrenches 20 to pivot away from the wrench disk 60 and lid 38 such that grips 70 of the lid wrenches 20 no longer engage the lid 38. Thus, the lid 38 is released from the jar opener 10 and the user may raise the housing 12 away from the jar to access the contents therein. It is understood by those skilled in the art that the jar opener 10 is not limited to the inclusion of both the start and release buttons 16, 18. For example, the lid wrenches 20 and gripping cams 22 may be rotated either inwardly or outwardly by activation of only a single button, switch, or touch screen, for example.

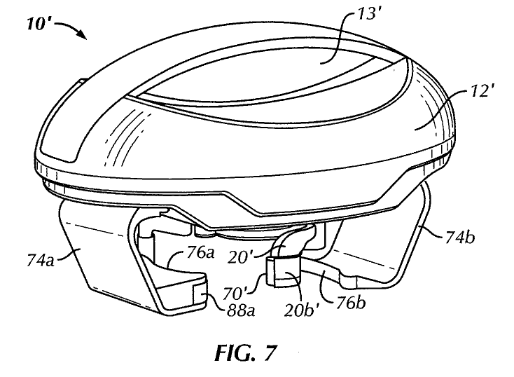

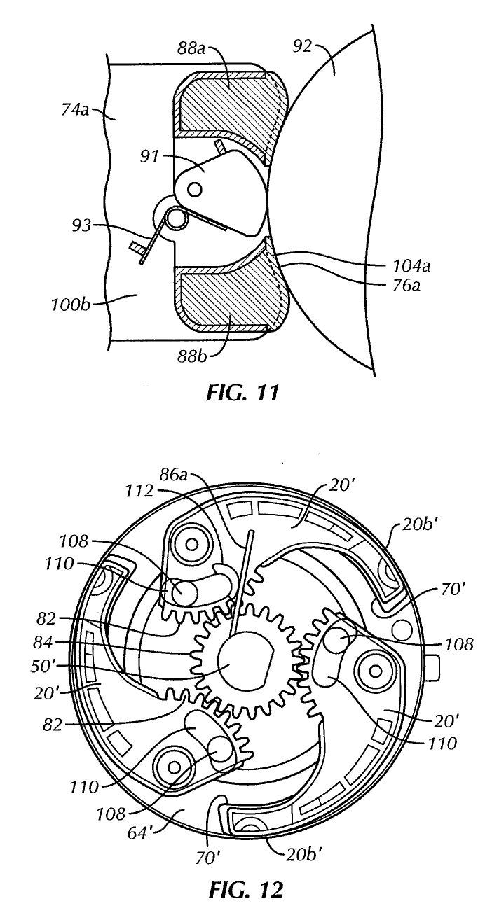

Referring now to FIGS. 7-13, a second preferred embodiment of the hand-held device for removing an enclosure from a container is shown, wherein like numerals are utilized to indicate like elements throughout and a prime symbol (′) is utilized to distinguish like components of the jar opener 10′ of the second preferred embodiment from the jar opener 10 of the first preferred embodiment. The jar opener 10′ of the second preferred embodiment is substantially similar in structure and operation to that of the first preferred embodiment described above. For example, similar to the first preferred embodiment, the jar opener 10′ of the second preferred embodiment is preferably an automated household or kitchen appliance for rotatably removing an enclosure or lid (not shown) from ajar or other container 92 (FIG. 11) that provides the user with a degree of “hands-free” operation such that the user does not have to directly hold or grasp the lid or the jar or impart energy to remove the lid from the jar.

As seen in FIG. 7, the jar opener 10′ includes a generally ovular housing 12′ having cut-outs or indentations diametrically opposed therein that form an integral handle 13′. Preferably, the housing 12′ is design to be the smallest size possible to create a more easily used, stored and/or transported jar opener 10′. The handle 13′ may be removably or pivotably attached to at least a portion of the housing 12′, but the housing 12′ is not limited to the inclusion of a handle 13′. Preferably, the housing 12′ at least partially encloses at least one motor 30′ and the exterior of the housing 12′ includes a button or switch (not shown) which allows the user to selectively operate the motor 30′. However, the jar opener 10′ may include two or more motors (not shown) and two or more buttons or switches (not shown) to allow the user to control operation of the motors or selectively reverse operation of one or both of the motors. The jar opener 10′ is preferably powered by at least one disposable or rechargeable battery (not shown) enclosed within a portion of the housing 12′. However, virtually any type of power source, such as a conventional power chord (not shown), a conventional battery (not shown), or solar powered energy cells (not shown), for example, may be used to provide energy to the motor 30′ of the jar opener 10′.

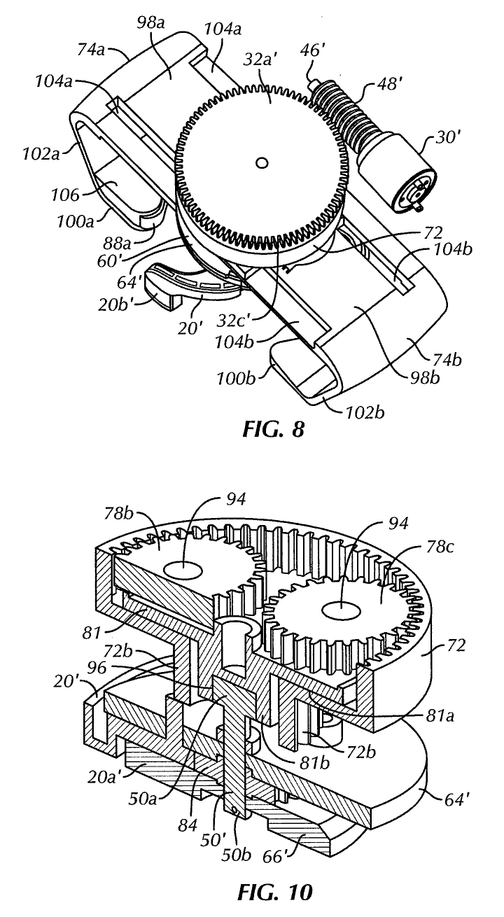

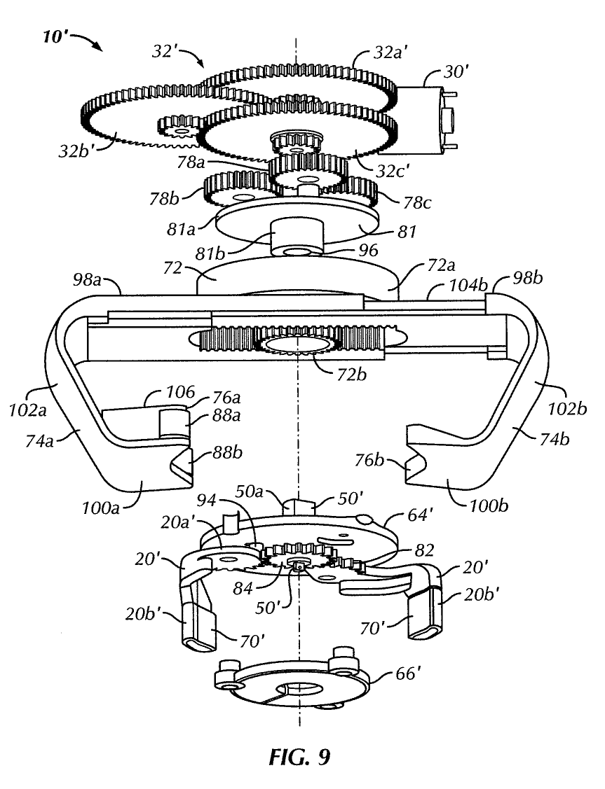

Referring to FIGS. 8 and 9, the housing 12′ preferably at least partially encloses a multi-stage gear train 32′. In FIG. 8 the gear train 32′ is only partially shown for clarity of other structure of the jar opener 10′. As will be described in more detail below, the gear train 32′ preferably operatively connects the at least one motor 30′ to a ring gear 72 and a drive shaft 50′ of the jar opener 10′. As is understood by those skilled in the art, a motor drive shaft 46′ extends from a portion of the motor 30′ and rotates a motor pinion 48′. The motor pinion 48′ is in direct engagement contact with the teeth of a first gear or drive gear 32a′ of the gear train 32′. Thus, power generated by the motor 30′ is transferred directly to the first gear 32a′. The first gear 32a′ of the gear train 32′ includes a pinion which engages and rotates a second gear or idle gear 32b′ (not shown in FIG. 8 for clarity) having a pinion, which in turn rotates a third gear or sun gear 32c′. A pinion portion of the third gear 32c′ is operatively connected to and engages three spaced-apart planetary gears 78a-78c that are at least partially housed within the ring gear 72.

As seen in FIGS. 9 and 10, a planet gear plate 81 is preferably positioned beneath the three planetary gears 78a-78c and within a portion the ring gear 72. The planet gear plate 81 includes a first or upper portion 81a including upwardly extending shafts 94 which directly support the three planetary gears 78a-78c for rotation and a second or lower portion 81b that extends downwardly therefrom. The second portion 81b includes a recess or depression 96 that is sized and shaped to matingly receive a portion of the drive shaft 50′. The three spaced-apart shafts 94, which preferably extend perpendicularly from the first portion 81a of the planet gear 81, are each sized and shaped to receive one of the planetary gears 78a-78c. Thus, as is understood by those skilled in the art, the planet gear plate 81 operatively connects the planetary gears 78a-78c to the drive shaft 50′. Further, the ring gear 72 is operatively connected to and rotatable by the at least one motor 30′. The ring gear 72 includes an upper portion 72a, which generally surrounds the three planetary gears 78a-78c and the planet gear plate 81, and a second or lower portion 72b that extends therefrom and is in the form of a pinion. The upper portion 72a is generally circular in shape when viewed from above or below and includes a series of teeth on an interior surface thereof to establish the ring gear 72 and to mesh with the teeth of each of the three planetary gears 78a-78c.

As seen in FIGS. 8 and 9, a pair of generally elongated rack sections 74a, 74b include teeth which are operatively connected to and movable by the pinion 72b of the ring gear 72. The rack sections 74a, 74b are movable in a first linear direction (i.e., inwardly toward a geometric center of the jar opener 10′), in which a container-gripping portion or mechanism 76a, 76b of each of the rack sections 74a, 74b grasps at least a portion of the container 92, and a second linear direction (i.e., outwardly away from the center of the jar opener 10′), in which the container gripping portion 76a, 76b of each rack section 74a, 74b is moved a predetermined distance away from the container 92. Each rack section 74a, 74b is generally “C” shaped when view from the side and includes a first or top surface 98a, 98b and a second or bottom surface 100a, 100b spaced therefrom by a sidewall 102a, 102b extending generally perpendicularly from both the top and bottom surfaces 98a, 98b, 100a, 100b. Preferably, each first surface 98a, 98b includes at least one but preferably two spaced-apart slots or grooves 104a, 104b that are each sized and shaped to conform to and/or receive at least a portion of the opposing top surface 98a, 98b, such that the rack sections 74a, 74b can be slid inwardly and outwardly in a smooth or fluid manner. Preferably, one of the grooves 104a, 104b in each of the first surfaces 98a, 98b is an opening or passageway that extends completely through the first surface 98a, 98b, while the other groove 104a, 104b is merely a depression or channel formed in the first surface 98a, 98b that does not extend through the first surface 98a, 98b.

Referring to FIGS. 7-9 and 11, the container-gripping portion 76a, 76b of at least one of the rack sections 74a, 74b includes at least one but preferably two spaced-apart elastomeric bodies 88a, 88b, which directly contact a portion of the container 92 when the rack sections 74a, 74b have been moved in the first linear direction. Specifically, at least one of the container-gripping portions 76, 76b of at least one of the rack sections 74a, 74b preferably is formed by the second or bottom surface 100a, 100b and a third surface 106 that is spaced from and extends generally parallel to the second surface 100a, 100b. Preferably, a predetermined and constant gap or spacing is maintained between the second surface 100, 100b and the third surface 106. The elastomeric bodies 88a, 88b are at least partially sandwiched between the two surfaces 100, 100b, 106 and are positioned at least partially within the spacing. It is preferred that the elastomeric bodies 88a, 88b are fixed in place with respect to the surfaces 100, 100b, 106. Preferably, the elastomeric bodies 88a, 88b extend at least slightly beyond an inner end of the surfaces 100, 100b, 106, such that portions of the elastomeric bodies 88a, 88b will contact and/or engage and grip at least a portion of the container 92 (see FIG. 11) when the rack sections 74a, 74b are moved in the first linear direction to grasp the container 92. The portion of each elastomeric body 88a, 88b that contacts the container 92 is preferably concavely shaped to conform to at least a portion of the convexly shaped container 92.

As seen in FIG. 11, a cam 91 is preferably rotatably positioned between the two spaced-apart elastomeric bodies 88a, 88b and between the surfaces 100a, 100b, 106. The cam 91 is generally eccentric in shape when viewed from above or below and has a predetermined height or thickness. A biasing member 93, such as a coil spring, may be positioned adjacent to at least one side of the cam 91 and between the two spaced-apart elastomeric bodies 88a, 88b and between the surfaces 100a, 100b, 106 to urge the cam 91 to a particular or desired rotational position. However, the jar opener 10′ is not limited to the inclusion of the biasing member 93, as the cam 91 may be freely rotatable between the two spaced-apart elastomeric bodies 88a, 88b and between the surfaces 100a, 100b, 106. In operation, the cam 91 helps to prevent slippage of the container 92 by engaging the container 92. Specifically, if the jar 92 begins to slip after the rack sections 74a, 74b are moved in the first linear direction, the movement of the jar 92 rotates the cam 91. As the cam 91 rotates, the distance between a pivot point and a cam profile gets larger, pushing harder into the jar 92 and thus increasing the friction force which helps to stop the slippage of the jar 92. One of ordinary skill in the art would understand that the cam 91 creates a break or stop in a similar manner as to that of a door stop, such that the harder the cam 91 gets pushed/turned by the jar 92, the harder the cam 91 grabs or grips the jar 92 to prevent slippage or continued movement.

Referring to FIGS. 9, 10, 12 and 13, the drive shaft 50′ is operatively connected to and rotatable by the at least one motor 30′. Preferably, the drive shaft 50′ is co-axially aligned with the ring gear 72, the planet gear plate 81 and the three planetary gears 78a-78c. The drive shaft 50′ is preferably in the shape of a “T” when viewed from the side, having an upper horizontally extending flange section 50a and a lower shaft portion 50b. The upper horizontally extending flange section 50a of the drive shaft 50′ preferably matingly fits within the similarly sized and shaped recess 96 of the planet gear plate 81, such that rotation of the planet gear plate 81 directly rotates the drive shaft 50′. When viewed from above or below, both the flange section 50a and shaft portion 50b of the drive shaft 50′ are preferably eccentrically shaped to prevent rotation of the drive shaft 50′ with respect to certain portions of the jar opener 10′

Referring to FIGS. 7-9, 12 and 13, the jar 10′ of the second preferred embodiment includes a lid wrench mechanism that preferably has at least two but preferably three equidistantly spaced-apart wrenches 20′ pivotably attached to the drive shaft 50′ for removably grasping the enclosure. The lid wrench mechanism also preferably includes a wrench disk 60′ formed of a top wrench disk 64′ and a bottom wrench disk 66′ that are separated a predetermined distance to allow for a first end 20a′ of each of the lid wrenches 20′ to be pivotably secured therebetween. Each lid wrench 20′ is preferably arcuate in shape when viewed from above or below and preferably includes a series of teeth 82 proximate the first end 20a′ thereof.

As seen in FIGS. 9, 10 and 12, a drive gear 84 is preferably fixedly attached to the shaft portion 50b of the drive shaft 50′. In operation, the series of teeth 82 of each wrench 20′ preferably operatively mate with the drive gear 84, such that operation of the motor 30′ rotates the drive gear 84, which in turn rotates each of the wrenches 20′. As seen in FIG. 10, the drive shaft 50′ preferably extends through the top wrench disk 64′, through the drive gear 84 and through the bottom wrench disk 66′. In addition, as seen in FIGS. 10, 12 and 13, at least a portion of each wrench 20′ extends through an opening within the top wrench disk 64′. Specifically, an extension 108 at the first end 20a′ of each wrench 20′ extends through an arcuate-shaped slot or opening 110 within the top wrench disk 64′. Thus, the top wrench disk 64′ includes three equidistantly spaced apart slots 110 therein which are sized and shaped to receive the extension 108 of one of the wrenches 20′ and conform to the path of motion of the extension 108 during operation of the wrenches 20′.

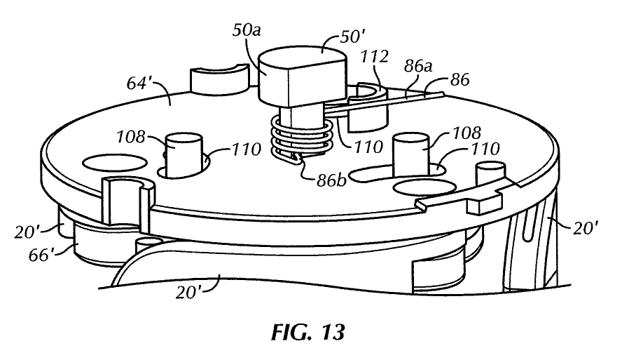

As seen in FIGS. 12 and 13, a torsion spring 86 preferably surrounds at least a portion of the drive shaft 50′. In operation, the spring 86 exerts a force on a portion the lid wrench mechanism, which causes the wrenches 20′ to rotate in the second rotational direction and a predetermined distance away from the enclosure. Specifically, a first arm 86a of the spring 86 abuts a partition 112 that extends from the top wrench disk 64′ and a second arm 86b of the spring 86 is mounted on the drive shaft 50′. Preferably, a free end of the second arm 86b is securely positioned within an opening in a side of the drive shaft 50′, such that the spring 86 is wound when the drive shaft 50′ turns while the wrench disk 60′ is stationary.

To operate the jar opener 10′, the user preferably manually pulls the rack section 74a, 74b in the second linear direction away from the geometric center of the jar opener 10′ and places the jar opener 10′ on top of a jar. However, it is understood by those skilled in the art that the initial step of moving the rack sections 74a, 74b may be automated such that the user presses a complimentary button (not shown) or actuates a complimentary switch (not shown) to automatically move the rack sections 74a, 74b away from the geometric center of the jar opener 10′. Next, the user pushes and/or slides the button or switch, or possibly the complimentary button or switch, to activate the motor 30′. As the motor 30′ turns, the force generated from the motor 30′ is transmitted through the gear train 32′ to the third gear 32c′. The third gear 32c′ is turned counterclockwise (when viewed from above) and rotates the three planetary gears 78a-78c, which turn clockwise and drive the ring gear 72. The ring gear 72 turns clockwise and pulls the rack sections 74a, 74b in the first linear direction inwardly to grasp the container 92. The rack sections 74a, 74b move toward a geometric center of the jar opener 10′ until the container-gripping portions 76a, 76b of each of rack sections 74a, 74b touch and engage the container 92. As was described above, the elastomeric bodies 88a, 88b and the cam 91 help to maintain a tight grip on the container 92.

Once the container-gripping portion 76a, 76b of the rack sections 74a, 74b have a firm grip on the container 92, the rack sections 74a, 74b cannot move inwardly any further and the ring gear 72 cannot turn. At this point, the planet gear plate 81 begins to turn or rotate clockwise (when viewed from above) because the ring gear 72 is stationery while the three planetary gears 78a-78c are still turning or rotating. The rotation of the planet gear plate 81 is what drives the lid wrench mechanism. The entire lid wrench mechanism would turn counterclockwise (when viewed from above), however the top and bottom wrench disks 64′, 66′ can not turn because the jar opener 10′ is placed on ajar lid, thus preventing the rotation.

While the top and bottom wrench disks 64′, 66′ are stationery in this position, the drive shaft 50′ continues to rotate by operation of the motor 30′. Thus, the drive shaft 50′ rotates the drive gear 84 in a counterclockwise direction (when viewed from above) and, in turn, engages the series of teeth 82 on each wrench 20′, thus rotating and pulling the wrenches 20′ inwardly toward a geometric center of the jar opener 10′. Meanwhile, the torsion spring 86, which is mounted between the drive shaft 50′ and the top wrench disk 64′, is being wound because the drive shaft 50′ is turning relative to the stationery top wrench disk 64′. Once the wrenches 20′ rotate inwardly and tighten against the lid or enclosure, the drive shaft 50′ and drive gear 84 can no longer rotate the wrenches 20′. From this moment, the entire lid wrench mechanism starts to rotate, which rotates the lid relative to the container 92. Once the user determines that the lid has been rotated free from the container 92, the user stops the motion by preferably letting go of the button or sliding the switch on the housing 12′ such that the motor 30′ stops. At this point, the wound torsion spring 86 inherently wants to relax and rotate the wrenches 20′ to their original position. However, the wrench disk 60′ can not move because it is still sitting on the jar.

Next, to remove the lid from the jar opener 10′, the user spreads the rack sections 74a, 74b in the second linear direction such that the rack sections 74a, 74b are moved a predetermined distance away from the container. Next, the user lifts the jar opener 10′ away from the container 92. Now, as the jar opener 10′ is not sitting on the jar anymore, the lid wrench mechanism is free to rotate. As the wrench disk 60′ turns counterclockwise (when viewed from above) due to the unwinding of the torsion spring 86, the wrenches 20′ rotate outwardly away from the geometric center of the jar opener 10′ because the drive shaft 50′ and the drive gear 84 are stationery. At this point, the lid can be removed from the lid wrench mechanism and the wrenches 20′ are back to their initial position and the jar opener 10′ is ready to begin operation again.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention.

I/we claim:

1. A hand-held device for removing an enclosure from a container, said device comprising:
a housing at least partially enclosing at least one reversible motor;
at least two spaced-apart cams pivotally attached to said housing, said cams being rotatable in a first rotational direction in which said cams grasp said container and in a second rotational direction in which said cams are rotated a predetermined distance away from said container;
a wrench disk operatively connected to and rotatable by said at least one motor; and
at least two spaced-apart wrenches pivotally attached to said wrench disk for removably grasping said enclosure,
wherein operation of said motor in a first direction rotates said wrench disk in a first rotational direction causing said wrenches to grasp and rotate said enclosure relative to said container and operation of said motor in a second direction rotates said wrench disk in a second rotational direction causing said wrenches to rotate a predetermined distance away from said enclosure.

2. The device according to claim 1, further comprising:
at least two spaced-apart shafts extending generally perpendicularly from a bottom surface of said housing, a first end of each shaft being rotatably attached to said housing and a second end of each shaft being fixedly attached to one of said cams.

3. The device according to claim 2, further comprising:
a drive belt at least partially enclosed by said housing and surrounding at least a portion of each shaft.

4. The device according to claim 3, further comprising:
a complimentary reversible motor operatively connected to said drive belt, wherein operation of said complimentary motor in a first direction rotates said drive belt in a first rotational direction causing said cams to rotate in said first rotation direction to grasp said container and operation of said complimentary motor in a second direction rotates said drive belt in a second rotational direction causing said cams to rotate in said second rotational direction a predetermined distance away from said container.

5. The device according to claim 1, further comprising:
a gear train at least partially enclosed within said housing and operatively connecting said at least one reversible motor to said wrench disk.

6. The device according to claim 1, further comprising:
at least three spaced-apart cams for removably grasping said container.

7. The device according to claim 6, further comprising:
at least three spaced-apart wrenches for removably grasping said enclosure.

8. The device according to claim 1, further comprising:
a handle pivotally attached to said housing and movable between a use position in which said handle is generally perpendicular to a top surface of said housing and a storage position in which said handle is generally parallel to said top surface of said housing.

9. The device according to claim 1 wherein each wrench is generally arcuate in shape and includes a first end and an opposite second end, wherein said first end of each wrench receives a pin to pivotally attach said wrench to said wrench disk.

10. The device according to claim 1, further comprising:
a plurality of spaced-apart legs generally extending perpendicular from a bottom surface of said housing, wherein said legs maintain a predetermined distance between said cams and a supporting surface when said device is placed on said supporting surface.

11. The device according to claim 1 wherein said cams extend in a plane generally parallel to and spaced a predetermined distance from a plane in which said wrenches extend.

12. A hand-held device for removing an enclosure from a container, said device comprising:
a housing at least partially enclosing at least one motor;
a ring gear operatively connected to and rotatable by said at least one motor, said ring gear having a pinion extending therefrom;
a pair of rack sections operatively connected to and movable by said pinion, said rack sections being movable in a first linear direction in which a container-gripping mechanism of each of said rack sections grasps said container and a second linear direction in which said container-gripping mechanism of each of said rack sections are moved a predetermined distance away from said container;
a drive shaft operatively connected to and rotatable by said at least one motor; and
at least two spaced-apart wrenches pivotally attached to said drive shaft for removably grasping said enclosure,
wherein operation of said motor rotates said drive shaft causing said wrenches to rotate in a first rotational direction to grasp and rotate said enclosure relative to said container.

13. The device according to claim 12, further comprising:
a gear train at least partially enclosed within said housing and operatively connecting said at least one motor to said ring gear and said drive shaft.

14. The device according to claim 13, further comprising:
three planetary gears operatively connecting said gear train to said ring gear; and
a planet gear plate operatively connecting said planetary gears to said drive shaft.

15. The device according to claim 12, further comprising:
at least three spaced-apart arcuate wrenches for removably grasping said enclosure, wherein a portion of each wrench includes a series of teeth; and
a drive gear fixedly attached to said drive shaft, wherein said series of teeth of each wrench operatively mate with said drive gear.

16. The device according to claim 12, further comprising:
a spring surrounding at least a portion of said drive shaft, wherein said spring exerts a force on a portion of said device causing said wrenches to rotate in a second rotational direction and a predetermined distance away from said enclosure.

17. The device according to claim 12, wherein said container-gripping mechanism of at least one of said rack sections includes two spaced-apart elastomeric bodies which directly contact a portion of said container.

18. The device according to claim 17, further comprising:
a cam rotatably positioned between said two spaced-apart elastomeric bodies of said container-gripping mechanism, wherein said cam engages said container to prevent slippage of said container.
